(19) United States
(12) Patent Application Publication
(10) Pub. No.: US 2026/0202786 A1
(43) Pub. Date: Jul. 16, 2026

(54) RECORDING MEDIUM PROCESSING DEVICE

(71) Applicant: Konica Minolta, Inc., Tokyo (JP)

(72) Inventors: Ryuji SATO, Toyokawa-shi (JP); Shogo ASAOKA, Toyokawa-shi (JP)

(21) Appl. No.: 19/451,257

(22) Filed: Jan. 16, 2026

(30) Foreign Application Priority Data
Jan. 16, 2025 (JP) 2025-006244

(51) Int. Cl. G03G 15/00; B65H 29/22; B65H 31/36

(52) U.S. Cl. CPC G03G 15/6552; B65H 29/22; B65H 31/36; B65H 2403/20; B65H 2404/1114; B65H 2404/152; B65H 2801/06

(57) ABSTRACT

A recording medium processing device stacks a plurality of recording media with edges of the plurality of recording media aligned. The recording medium processing device includes: a storage tray on which the plurality of recording media conveyed from a conveyance route is stacked; a restrictor that is provided at one end of the storage tray and that aligns the edges of the plurality of recording media; a rotary conveyor that conveys the plurality of recording media on the storage tray toward the restrictor; and a supporter that rotatably supports the rotary conveyor. The supporter is provided with an adjuster that adjusts a distance from the rotary conveyor to the storage tray or each of the plurality of recording media on the storage tray.

### CROSS REFERENCE TO RELATED APPLICATION

The present invention claims priority under 35 U.S.C. § 119 to Japanese Patent Application No. 2025-006244 filed on Jan. 16, 2025, the entire content of which is also incorporated herein by reference.

### BACKGROUND OF THE INVENTION

### Technical Field

The present disclosure relates to a recording medium processing device.

### Description of Related Art

An image forming apparatus includes a recording medium processing device that stacks recording media ejected onto a storage tray from an ejection section on a conveyance route with the edges of the recording media aligned.

The recording medium processing device includes the storage tray onto which the recording media are ejected, a stopper that aligns the edges of the recording media, and a rotary conveyance body (rotary conveyor) that sends the recording media toward the stopper.

The recording medium processing device can move the rotary conveyance body toward or away from the recording media on the storage tray by rotationally driving a motor.

Then, the recording media are conveyed toward the stopper by the rotation of the rotary conveyance body once brought closer and are stacked with the edges aligned (see Japanese Patent No. 6879488).

### SUMMARY OF THE INVENTION

The strength of the conveying force of the rotary conveyance body varies depending on the distance to the recording media. When the conveying force is weak, the recording medium may not reach the stopper. When the conveying force is strong, the recording medium may be pressed against the stopper and buckle.

Therefore, fine adjustment of the distance between the rotary conveyance body and the recording medium or the tray is required.

However, in conventional apparatuses, a large number of components are interposed between a motor that moves the rotary conveyance body toward or away and the rotary conveyance body. For this reason, the fine adjustment is easily affected by the machining accuracy of these interposed components. Therefore, it has been difficult to finely adjust the distance from the rotary conveyance body to the recording medium or the tray by controlling the operation amount of the motor.

An object of the present disclosure is to perform fine adjustment of the distance from a rotary conveyance body to a recording medium or a storage tray.

To achieve at least one of the abovementioned objects, a recording medium processing device reflecting one aspect of the present invention is a recording medium processing device that stacks a plurality of recording media with edges of the plurality of recording media aligned and comprises: a storage tray on which the plurality of recording media conveyed from a conveyance route is stacked; a restrictor that is provided at one end of the storage tray and that aligns the edges of the plurality of recording media; a rotary conveyor that conveys the plurality of recording media on the storage tray toward the restrictor; and a supporter that rotatably supports the rotary conveyor, wherein the supporter is provided with an adjuster that adjusts a distance from the rotary conveyor to the storage tray or each of the plurality of recording media on the storage tray.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic configuration diagram of an image forming apparatus according to a first embodiment;

FIG. 2 is a front view of an inner configuration of a post-processing device when a conveyance unit is at a retracted position;

FIG. 3 is a front view of an inner configuration of the post-processing device when the conveyance unit is at a conveyance position;

FIG. 4 is a perspective view of a configuration of a portion of the post-processing device when the conveyance unit is at the retracted position;

FIG. 5 is a perspective view of a configuration of a portion of the post-processing device when the conveyance unit is at the conveyance position;

FIG. 6 is a side view of the conveyance unit at the retracted position as viewed from the left;

FIG. 7 is a side view of the conveyance unit at the conveyance position as viewed from the left;

FIG. 8 is an exploded perspective view of the conveyance unit;

FIG. 9 is a side view of a support part with a holder and a movable member at their standard positions;

FIG. 10 is a side view of the support part with the holder and the movable member forming a maximum angle;

FIG. 11 is a side view of the support part with the holder and the movable member forming a minimum angle;

FIG. 12 is a side view of the conveyance unit as viewed from the left when the holder and the movable member form the maximum angle;

FIG. 13 is a side view of the conveyance unit as viewed from the left when the holder and the movable member form the minimum angle;

FIG. 14 is a diagram illustrating an operation of the post-processing device;

FIG. 15 is a diagram illustrating the operation of the post-processing device continued from FIG. 14;

FIG. 16 is a diagram illustrating the operation of the post-processing device continued from FIG. 15;

FIG. 17 is a diagram illustrating the operation of the post-processing device continued from FIG. 16;

FIG. 18 is a diagram illustrating the operation of the post-processing device continued from FIG. 17;

FIG. 19 is a diagram illustrating the operation of the post-processing device continued from FIG. 18;

FIG. 20 is a perspective view of a conveyance unit according to a second embodiment;

FIG. 21 is an enlarged perspective view of the conveyance unit according to the second embodiment;

FIG. 22 is a side view of the conveyance unit as viewed from the left when a movable member is at its rearmost position relative to a holder; and

FIG. 23 is a side view of the conveyance unit as viewed from the left when the movable member is at its foremost position relative to the holder.

### DETAILED DESCRIPTION

### First Embodiment

In the following, a first embodiment of the present disclosure will be described with reference to the drawings. The scope of the present disclosure is not limited to the embodiments disclosed below or the illustrations in the drawings.

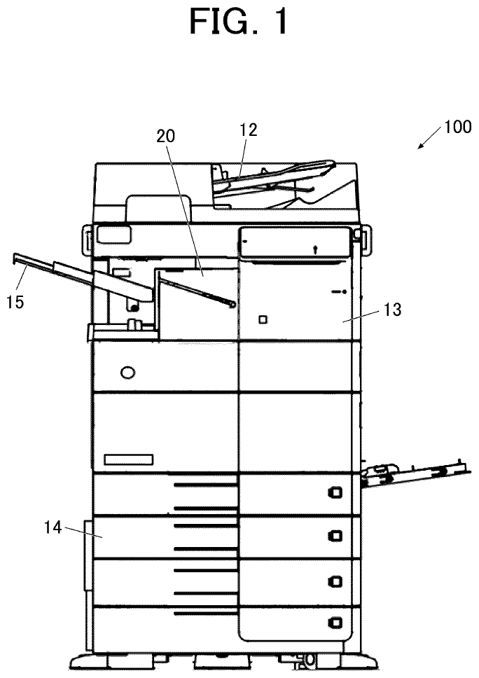

FIG. 1 is a front view of an image forming apparatus 100 according to the present embodiment. The image forming apparatus 100 forms a color image on a recording medium P, such as a cut sheet, by an electrophotographic method. The image forming apparatus 100 forms an image based on image data obtained by reading an image from a document or image data received from an external device. The image forming apparatus 100 includes an operation part 11, a document reading unit 12, an image forming section 13, a feeding section 14, and a post-processing device 20.

The operation part 11 outputs an operation signal based on an operation by a user to a controller (not shown). The operation part 11 includes various operation keys, a display part, and a touch screen. The various operation keys receive various user instructions. The touch screen is formed so as to cover a display screen of the display part. The touch screen receives a touch operation on the display screen and detects a touch position.

The display part includes a liquid crystal display (LCD). The display part displays various screens in accordance with instructions of display signals input from the controller.

The document reading unit 12 includes an automatic document feeder (ADF) and a scanner. The document reading unit 12 outputs image data obtained by reading an image of a document to the controller.

The image forming section 13 forms an image on the recording medium P fed from the feeding section 14. The image forming section 13 includes photosensitive drums corresponding to respective colors of yellow, magenta, cyan, and black. The image forming section 13 further includes an intermediate transfer belt, a secondary transfer roller, a fixing section, and a reversing mechanism.

The image forming section 13 uniformly charges the photosensitive drum for each color and then scans and exposes the photosensitive drum with a laser based on image data of each color to form an electrostatic latent image. Next, the image forming section 13 causes toner of a color corresponding to the electrostatic latent image on the photosensitive drum of each color to adhere thereto, to develop the electrostatic latent image.

Furthermore, the image forming section 13 primarily transfers the toner images of the respective colors formed on the photosensitive drums of the respective colors onto the intermediate transfer belt in a superimposed manner. Then, the image forming section 13 secondarily transfers the color toner images on the intermediate transfer belt onto the recording medium P at once by the secondary transfer roller.

The fixing section fixes the secondarily transferred color toner image to the recording medium P by heating and pressing.

The feeding section 14 includes a plurality of feeding trays. The feeding section 14 feeds the recording medium P from a selected feeding tray to the image forming section 13. Each of the feeding trays individually stores the recording media P of a predetermined paper type and size.

### Post-Processing Device: Overall Configuration

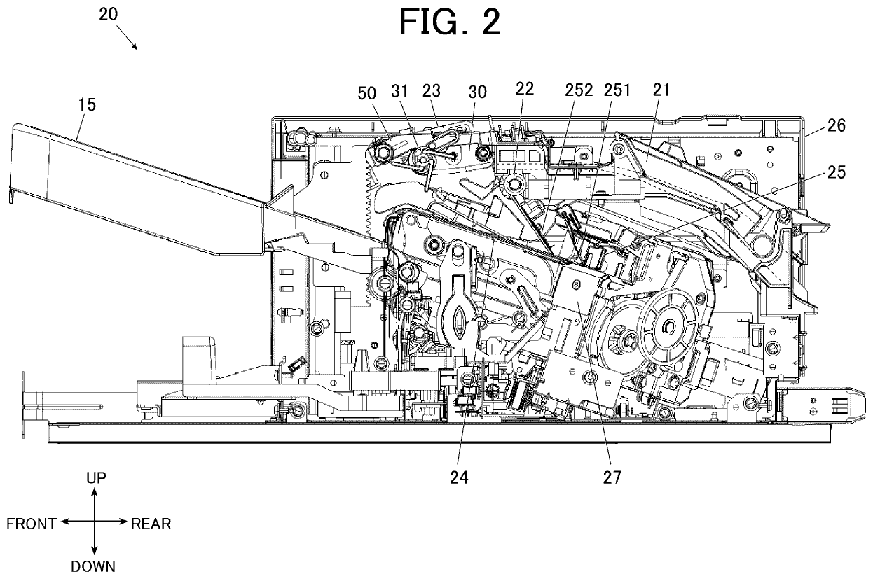

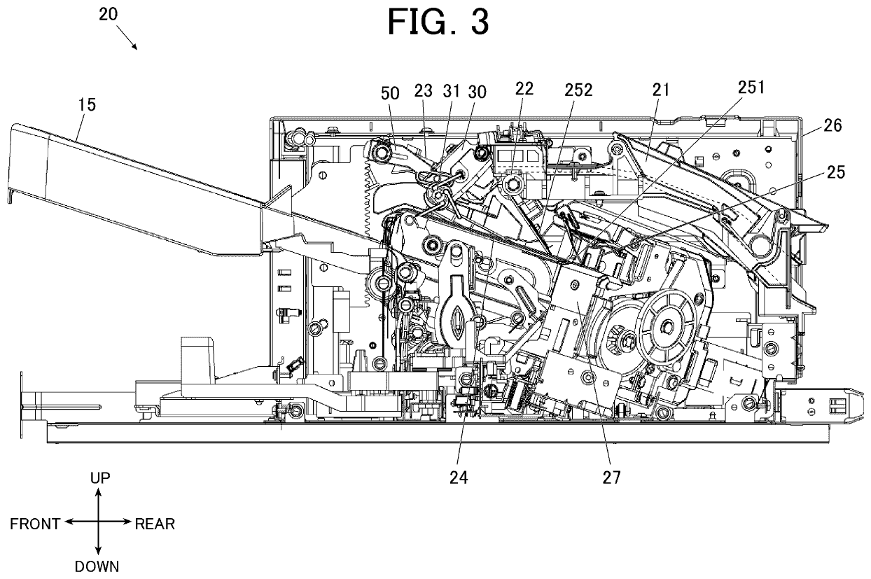

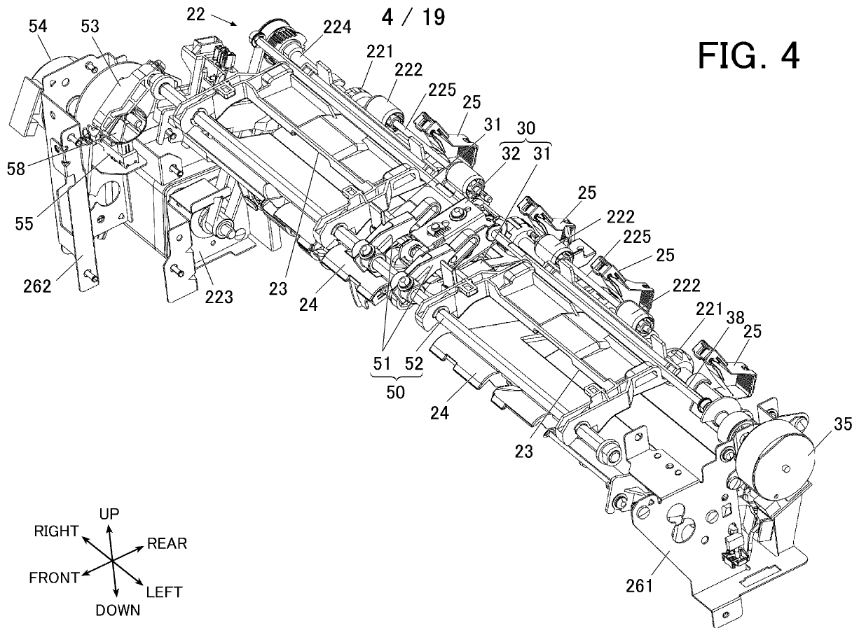

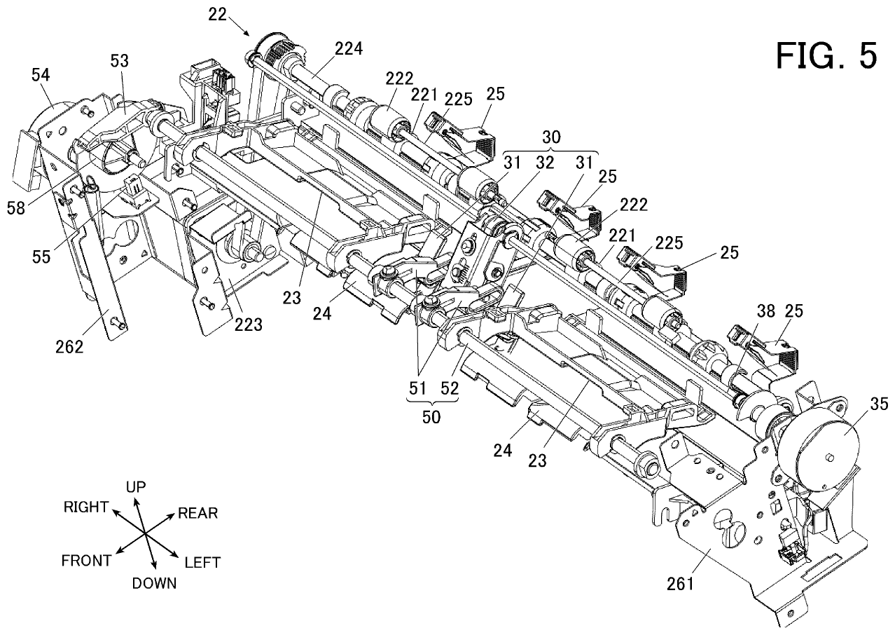

FIGS. 2 and 3 are front views of the inner configuration of the post-processing device 20. FIGS. 4 and 5 are perspective views of the configuration of a portion of the post-processing device 20. FIGS. 2 and 4 illustrate a conveyance unit 30 to be described later at a retracted position. FIGS. 3 and 5 illustrate the conveyance unit 30 at a conveyance position where the conveyance unit 30 performs conveyance.

The image forming apparatus 100 includes an ejection tray 15 on which image-formed recording media P that have been ejected from the apparatus are placed. The post-processing device 20 is disposed upstream of the ejection tray 15 on a conveyance route of the recording media P.

In the following description, in the horizontal direction, the side of the post-processing device 20 where the ejection tray 15 is located is referred to as the “front” and the side of the post-processing device 20 where the image forming section 13 is located is referred to as the “rear”. The horizontal direction orthogonal to the front-rear direction is referred to as a left-right direction. In this case, when facing frontward, the left side is referred to as “left” and the right side as “right”. Furthermore, a vertically upward direction is referred to as “up” and a vertically downward direction as “down”.

The post-processing device 20 performs, as necessary, post-processing on the recording medium P on which the image has been formed by the image forming section 13. The post-processing includes, for example, cutting processing, sorting processing, stapling processing, punching processing, folding processing, and bookbinding processing. In any of these post-processing steps, it is necessary to perform a specific process after the plurality of recording media P is stacked with their edges aligned. That is, the post-processing device 20 has a function as a recording medium processing device that stacks a plurality of recording media P with their edges aligned.

In the following description, a post-processing device 20 that performs stapling processing will be exemplified. Note that the post-processing device 20 may perform any processing for stacking a plurality of recording media P with their edges aligned, not limited to stapling processing.

The post-processing device 20 includes a path member 21, a conveyance section 22, sorting members 23, storage trays 24, end stoppers 25, and a housing 26. Furthermore, the post-processing device 20 includes a conveyance unit 30, a moving mechanism (moving structure) 50, and a stapling unit 27.

As shown by the dashed lines in FIGS. 2 and 3, the path member 21 has a conveyance route formed internally that connects to the conveyance route of the image forming section 13.

The conveyance section 22 is disposed at a front end of the path member 21, which is downstream of the path member 21 in a conveyance direction.

The conveyance section 22 includes a plurality of drive rollers 221 and a plurality of driven rollers 222 arranged vertically, and a conveyance motor 223 that serves as a conveyance drive source.

Each drive roller 221 is fixedly provided on a drive shaft 224 extending in the left-right direction. The drive shaft 224 is driven by the conveyance motor 223 via a belt to rotate the drive rollers 221 at the same time.

Above the drive shaft 224, two rotary shafts 225 are supported so as to be movable up and down. Two of the driven rollers 222 are rotatably supported by each rotary shaft 225. The rotary shafts 225 are pressed downward so that each driven roller 222 is in pressure contact with the corresponding drive roller 221. Thus, the drive rollers 221 and the driven rollers 222 can stably feed the recording medium P toward the front with a constant pressure.

Two sorting members 23 are provided side by side in the left-right direction. Each sorting member 23 is disposed on the front side of the conveyance section 22. The ejection tray 15 is disposed in front of the sorting members 23.

The sorting member 23 is a plate-like body that can be substantially aligned along the conveyance route, with its front end pivotally supported by the housing 26 along the left-right direction via a shaft.

This shaft allows a rear end of the sorting member 23 to swing vertically.

When the rear end of the sorting member 23 swings upward, the entire plate surface is retracted above the conveyance route. In this retracted state, the sorting member 23 allows the recording medium P from the conveyance section 22 to pass underneath and be directly conveyed to the ejection tray 15.

The storage trays 24 are disposed below the respective sorting members 23. Therefore, the rear end of the recording medium P ejected from the conveyance section 22 can be directed toward the storage trays 24 by the downward swing of the sorting members 23.

Note that the swinging operation of the sorting members 23 is provided by the moving mechanism 50 described later.

Two storage trays 24 are provided side by side in the left-right direction. Each storage tray 24 has a placement surface that inclines obliquely downward to the rear. Therefore, the recording medium P fed onto the storage trays 24 is easily moved rearward.

In addition, a plurality of end stoppers 25, which are substantially U-shaped and open toward the front, are provided at the rear end of the storage tray 24. The width of each end stopper 25 in the left-right direction is sufficiently narrower than the width of the recording medium P. The end stoppers 25 are arranged next to each other in the left-right direction.

The recording medium P fed onto the storage trays 24 can be abutted against the rearmost positions of the end stoppers 25 by the conveyance of the conveyance unit 30.

Therefore, by successively abutting the recording media P conveyed one after another against the end stoppers 25, the recording media P can be stacked while aligning their edges. Each of the end stoppers 25 functions as a restricting member (restrictor) for aligning the edges of the plurality of stacked recording media P at one end of the storage tray 24.

Inside each end stopper 25, a pressing spring 251 formed of a plate spring for pressing down on the rear end of the recording medium P from above is provided.

Furthermore, a pressing plate 252 that is swingably supported and presses the recording medium P on the storage tray 24 by its own weight is disposed on the front side of the end stopper 25.

The stapling unit 27 is disposed behind the end stopper 25 and is movable in the left-right direction. The stapling unit 27 has an opening formed facing frontward for inserting the edges of the stacked recording media P.

Then, when the recording media P are stacked on the storage tray 24 with their rear ends aligned, the stapling unit 27 moves to a predetermined position in the left-right direction. Furthermore, the stapling unit 27 moves frontward to insert the rear ends of the recording media P into the opening at a position avoiding the end stoppers 25. Then, within the opening, the stapling unit 27 can bind the stacked recording media P by driving a staple needle N through the rear ends of the recording media P.

### Post-Processing Device: Conveyance Unit

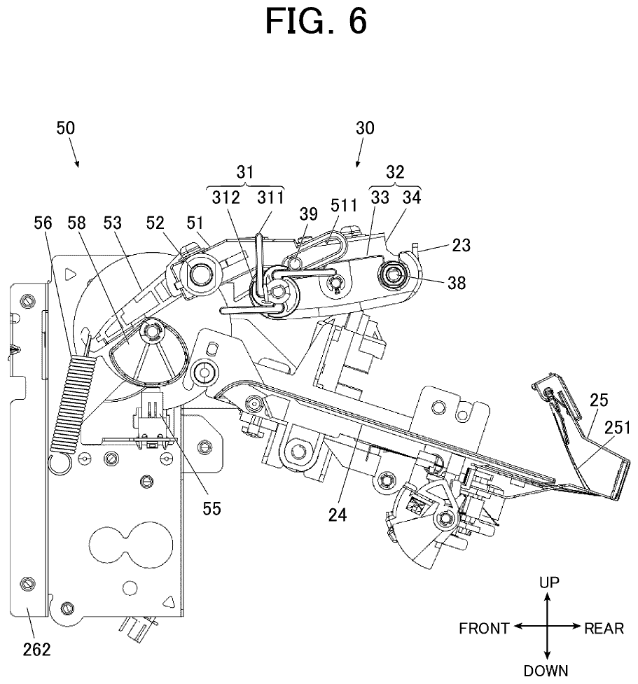

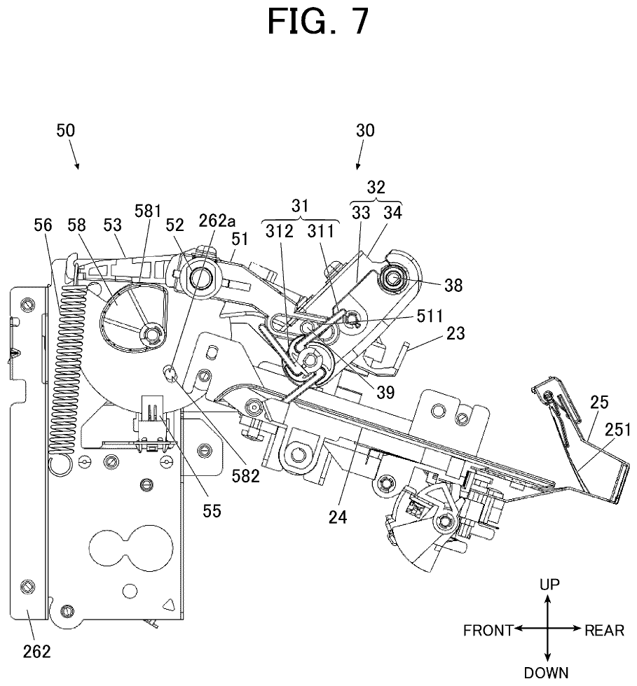

FIGS. 6 and 7 are side views of the conveyance unit 30 as viewed from the left. FIG. 6 illustrates the conveyance unit 30 at a retracted position. FIG. 7 illustrates the conveyance unit 30 at the conveyance position where the conveyance unit 30 performs conveyance.

As illustrated in FIGS. 4 to 7, the conveyance unit 30 includes rotary conveyance bodies (rotary conveyors) 31, a support part (supporter) 32, a paddle motor 35, a rotary shaft 37, a support shaft 38, input shafts 39, and an adjustment part (adjuster) 40.

The support shaft 38 extends in the left-right direction across substantially the entire width of the housing 26 in the left-right direction within the housing 26 and is rotatably supported by the housing 26.

The support shaft 38 supports the support part 32 by passing through the support part 32 at the midpoint in the left-right direction. The support part 32 rotatably supports the rotary conveyance bodies 31 via the rotary shaft 37. The support shaft 38 has a function of transmitting rotational power to the rotary conveyance bodies 31 supported by the support part 32. Therefore, the support shaft 38 has its left end coupled to the output shaft of the paddle motor 35, where a rotational force is input. The paddle motor 35 is supported by a left bracket 261 provided upright inside the left end of the housing 26.

The rotary conveyance bodies 31 are provided respectively at one end and the other end of the rotary shaft 37 extending in the left-right direction. Each rotary conveyance body 31 includes a plurality of paddles 311 and a paddle holder 312 that holds the plurality of paddles 311. A distal end portion of each paddle 311 is brought into contact with the recording medium P to feed the recording medium P in a predetermined direction.

Each paddle 311 is formed of a strip-shaped rectangular flat plate made of an elastic member such as rubber. One end portion of each paddle 311 extends from an outer periphery of a substantially cylindrical paddle holder 312 in a tangential direction, and its distal end portion is brought into contact with the recording medium P. Then, with the rotation of the paddle holder 312, the recording medium P can be stably fed by the elastic force of the paddle 311.

Three paddles 311 are provided at intervals of 90° in a circumferential direction with respect to the paddle holder 312. That is, a paddle 311 is not provided in one of the four uniformly divided regions of the outer periphery of the paddle holder 312. Each of the rotary conveyance bodies 31 is switched between the upper, retracted position and the lower, conveyance position by the swinging of the support part 32 around the support shaft 38. Therefore, to avoid collision between the paddle 311 and the recording medium P during this switching, a region where the paddle 311 is absent is provided.

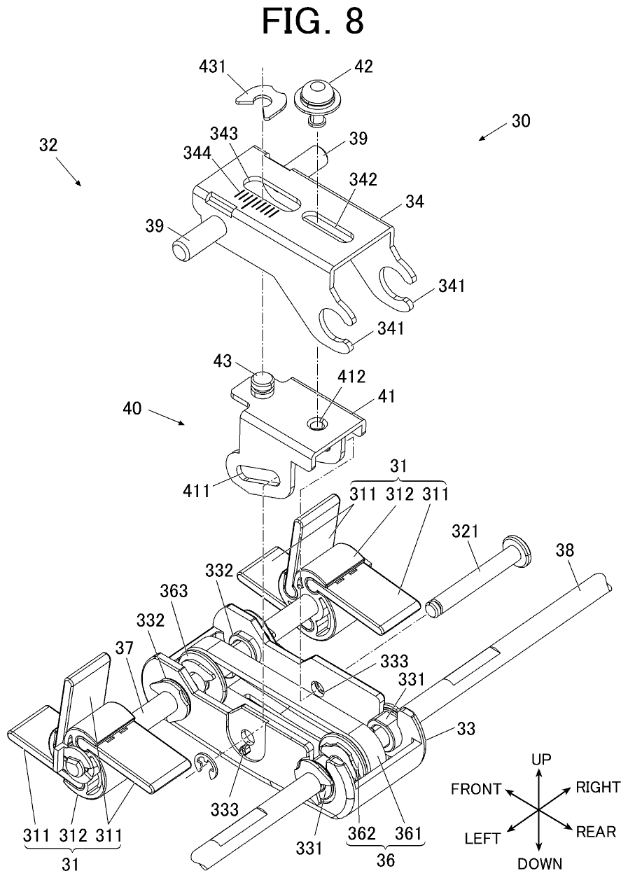

FIG. 8 is an exploded perspective view of the support part 32 and the adjustment part 40.

The support part 32 includes a holder 33 that supports the rotary shaft 37 and a movable body 34 that has the input shafts 39.

The holder 33 is a frame body that has left and right sidewall portions and a bottom surface portion and has an open cross-sectional shape opened upward. The support shaft 38 is inserted through a rear end portion of the holder 33 via a pair of left and right bearing members 331. The support shaft 38 is rotatable with respect to the holder 33 by the left and right bearings 331.

Further, the rotary shaft 37 is inserted through a front end portion of the holder 33 via a pair of left and right bearing members 332. The rotary shaft 37 is also rotatable with respect to the holder 33 by the left and right bearing members 332.

A transmission mechanism 36 that transmits a rotational force from the support shaft 38 to the rotary shaft 37 is housed inside the holder 33. The transmission mechanism 36 includes a drive sprocket 362 fixedly mounted on the support shaft 38 and a driven sprocket 363 fixedly mounted on the rotary shaft 37. Further, the transmission mechanism 36 includes an endless annular drive belt 361 wound around the drive sprocket 362 and the driven sprocket 363.

As described above, the support shaft 38 is rotationally driven by the paddle motor 35. Next, the rotational force is transmitted from the support shaft 38 to the rotary shaft 37 via the drive sprocket 362, the drive belt 361, and the driven sprocket 363 of the transmission mechanism 36. Thus, the left and right rotary conveyance bodies 31 are rotationally driven with the paddle motor 35 as a drive source.

The movable body 34 is a frame body that has left and right sidewall portions and a top surface portion and has an open cross-sectional shape opened downward. The movable body 34 is coupled to the holder 33 so as to close the opened upper portion of the holder 33. The movable body 34 is coupled to the holder 33 such that the left and right sidewall portions of the movable body 34 are positioned inwardly relative to the left and right sidewall portions of the holder 33.

A pair of leg portions 341 extending rearward and obliquely downward are provided at rear end portions of the left and right sidewall portions of the movable body 34. Distal end portions of the pair of leg portions 341 have a substantially C-shape and individually hold outer peripheries of cylindrical portions of the pair of bearing members 331. Thus, the movable body 34 and the holder 33 can relatively swing around the support shaft 38.

On front sides of the left and right sidewall portions of the movable body 34, a pair of input shafts 39 protruding outward in the left-right direction are provided at positions not interfering with the left and right sidewall portions of the holder 33. The pair of input shafts 39 are both parallel to each other in the left-right direction and are disposed on the same axis.

The pair of input shafts 39 receives an input from a pair of left and right input arms 51 of the moving mechanism 50 to swing the entire support part 32 via the support shaft 38. That is, the moving mechanism 50 inputs, via the pair of input shafts 39, the operation to switch the pair of rotary conveyance bodies 31 between the upper, retracted position and the lower, conveyance position.

Furthermore, the pair of input shafts 39 are not formed as a single shaft but are provided on both the left and right sides, sandwiching the drive belt 361. Therefore, it is not necessary to dispose the pair of input shafts 39 above the drive belt 361 in order to avoid interference with the drive belt 361. Therefore, the size of the support part 32 in the up-down direction can be reduced.

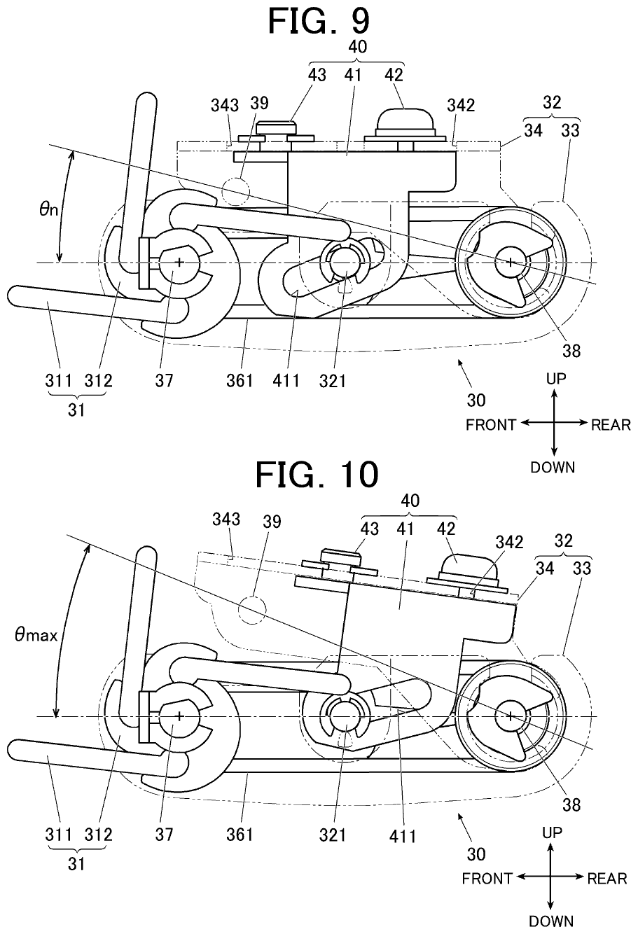

FIG. 9 to FIG. 11 are side views of the support part 32, illustrating changes of the components due to adjustment by the adjustment part 40.

Between the holder 33 and the movable body 34 of the support part 32, the adjustment part 40 for adjusting the distance from each rotary conveyance body 31 to the upper surface of the storage tray 24 is provided. Hereinafter, the distance from each rotary conveyance body 31 to the upper surface of the storage tray 24 is referred to as “the height of the rotary conveyance body 31”.

The adjustment part 40 adjusts the height of each rotary conveyance body 31 with respect to the upper surface of the storage tray 24 by adjusting the angle θn shown in FIG. 9. The angle θn indicates the angle formed between a plane containing the centerlines of the support shaft 38 and the rotary shaft 37, and a plane containing the centerlines of the support shaft 38 and the pair of input shafts 39.

The adjustment part 40 includes an adjustment body 41, a coupling member 42, and a guide protrusion 43. Since the movable body 34 is related to the adjustment of the height of the rotary conveyance body 31, the movable body 34 may be considered part of the adjustment part 40.

The adjustment body 41 can hold the holder 33 and the movable body 34 at any desired angle θn. The adjustment body 41 is a frame body that has left and right sidewall portions and a top surface portion and has an open cross-sectional shape opened downward. The adjustment body 41 is stored inside the movable body 34 so as to be movable in the front-rear direction. The adjustment body 41 is coupled such that the left and right sidewall portions and the top surface portion of the adjustment body 41 are adjacent to the left and right sidewall portions and the top surface portion of the movable body 34.

The guide protrusion 43 is provided so as to protrude upward from an upper surface of a front end portion of the top surface portion of the adjustment body 41. An insertion hole 412 through which the coupling member 42 is inserted is formed vertically through an upper surface of a rear end portion of the top surface portion of the adjustment body 41.

Long holes 343 and 342 extending in the front-rear direction are formed through the front side and the rear side of the top surface portion of the movable body 34, respectively.

The width of the long hole 343 in the left-right direction substantially matches the outer diameter of the guide protrusion 43, and the guide protrusion 43 is inserted through the long hole 343 from below. An E-ring 431 is attached to an upper end portion of the guide protrusion 43 to couple the movable body 34 to the adjustment body 41.

To the left of the long hole 343, a scale 344 is provided. The scale 344 is for reading the front-rear position of the guide protrusion 43. The front-rear position of the guide protrusion 43 is correlated with the height of the rotary conveyance body 31 with respect to the storage tray 24. Therefore, it is possible to adjust the height of the rotary conveyance body 31 with respect to the storage tray 24 while reading the front-rear position of the guide protrusion 43 from the scale 344.

Further, the guide protrusion 43 and the adjustment body 41 can be moved steplessly, that is, continuously with respect to the movable body 34. Accordingly, the height of the rotary conveyance body 31 can also be adjusted in a stepless manner.

The width of the long hole 342 in the left-right direction substantially matches the outer diameter of a shaft of the coupling member 42, and the shaft of the coupling member 42 is inserted through the long hole 342 from above. The coupling member 42 has a slightly enlarged diameter at the tip of the shaft. When the shaft of the coupling member 42 is pushed into the insertion hole 412 of the adjustment body 41 through the long hole 342, the coupling member 42 couples the movable body 34 to the adjustment body 41.

The movable body 34 and the adjustment body 41 are coupled to each other by the long holes 343 and 342, the guide protrusion 43 and the coupling member 42 so as to be relatively movable in the front-rear direction.

When the movable body 34 and the adjustment body 41 are coupled to each other by the coupling member 42, the lower surface of the top surface portion of the movable body 34 and the upper surface of the top surface portion of the adjustment body 41 are appropriately pressed against each other. Thus, the movable body 34 and the adjustment body 41 cannot relatively move in the front-rear direction unless a force of a certain level or more is applied.

The coupling member 42 may be formed of a fastening member such as a screw, and the insertion hole 412 may be formed of a screw hole, so that the movable body 34 and the adjustment body 41 can be fastened to each other. In this case, when the coupling member 42 is loosened, the movable body 34 and the adjustment body 41 can move in the front-rear direction, and when the coupling member 42 is tightened, the movable body 34 and the adjustment body 41 can be fixed.

In lower end portions of left and right sidewall portions of the adjustment body 41, long holes 411 are formed at the same positions when viewed from the left-right direction, with the same dimensions and along the same direction. A coupling shaft 321 to be held in through holes 333 in the left and right sidewall portions of the holder 33 is inserted through the left and right long holes 411.

Thus, the holder 33 and the adjustment body 41 are coupled to each other by the coupling shaft 321. In addition, since the adjustment body 41 and the movable body 34 are coupled to each other, the holder 33 and the movable body 34 are coupled to each other via the adjustment body 41.

The coupling shaft 321 is disposed in the holder 33 such that the coupling shaft 321 passes inside the drive belt 361, thereby avoiding interference with the drive belt 361.

The left and right long holes 411 are formed obliquely upward and rearward. Therefore, when the adjustment body 41 is moved rearward relative to the movable body 34, the long holes 411 push the movable body 34 and the adjustment body 41 upward via the coupling shaft 321. This increases the angle θn. As illustrated in FIG. 10, when the adjustment body 41 is moved to the rear end of its movable range, the angle θn can be increased to the maximum angle θmax.

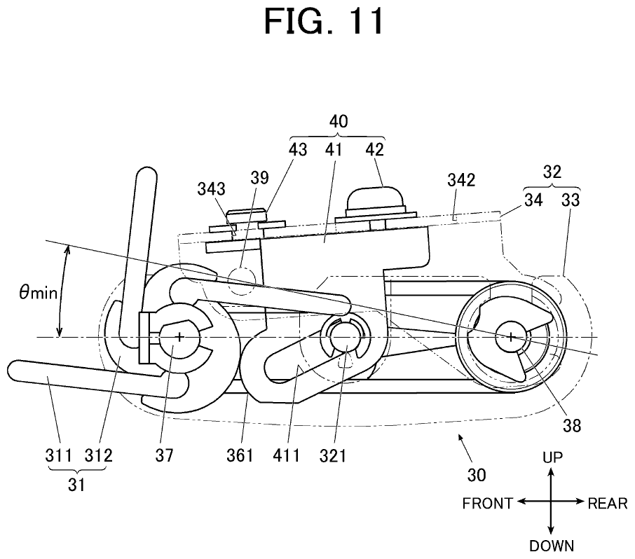

Furthermore, when the adjustment body 41 is moved toward the front relative to the movable body 34, the long holes 411 push the movable body 34 and the adjustment body 41 downward via the coupling shaft 321. This decreases the angle θn. As illustrated in FIG. 11, when the adjustment body 41 is moved to the front end of the movable range, the angle θn can be reduced to the minimum angle θmin.

Note that, in side view, the long holes 411 need not be parallel to the plane containing the centerlines of the support shaft 38 and the rotary shaft 37, and they may instead be inclined obliquely downward toward the rear. In this case, when the adjustment body 41 is moved rearward, the angle θn decreases, and when the adjustment body 41 is moved frontward, the angle θn increases.

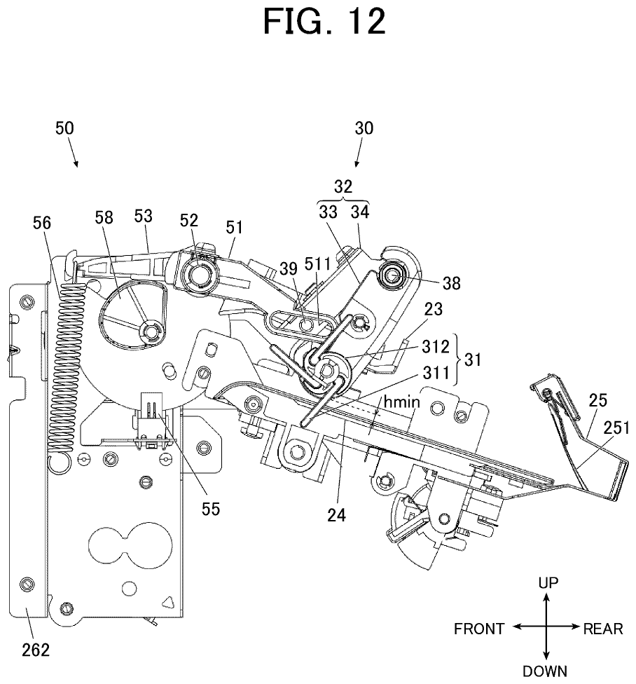

FIG. 12 is a side view of the conveyance unit 30 showing the height of the rotary conveyance body 31 with respect to the storage tray 24 when the angle θn is increased to the maximum angle θmax.

In this case, the input shaft 39 is restrained by the input arm 51, and the rotary conveyance body 31 at the front end portion of the holder 33 forming the angle θmax with the movable body 34 moves downward. Therefore, the rotary conveyance body 31 is at a distance hmin, closest to the upper surface of the storage tray 24.

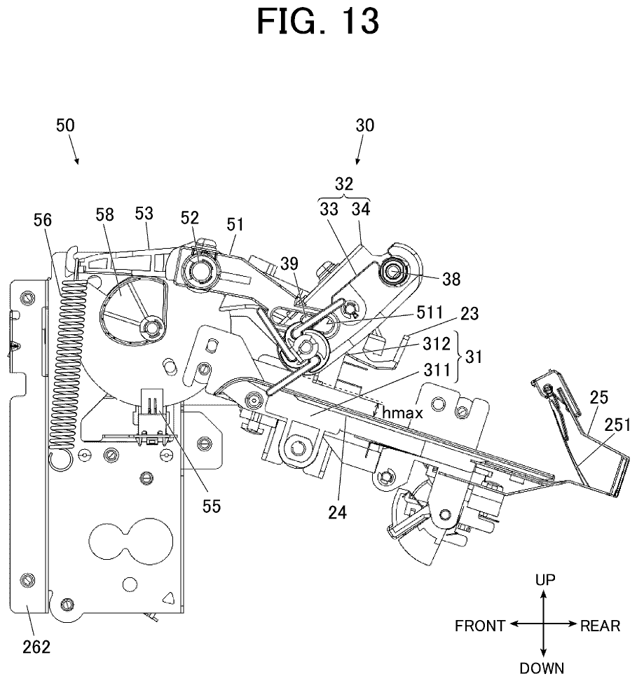

FIG. 13 is a side view of the conveyance unit 30 showing the distance from the rotary conveyance body 31 to the storage tray 24 when the angle θn is decreased to the minimum angle θmin.

In this case, the input shaft 39 is restrained by the input arm 51, and the rotary conveyance body 31 at the front end portion of the holder 33 forming the angle θmin with the movable body 34 is spaced apart upwardly. Therefore, the rotary conveyance body 31 is at a distance hmax, farthest from the upper surface of the storage tray 24.

In this way, the height of each rotary conveyance body 31 with respect to the upper surface of the storage tray 24 can be adjusted by the front-rear movement of the adjustment body 41 of the adjustment part 40.

### Post-Processing Device: Moving Mechanism

As illustrated in FIGS. 4 to 7, the moving mechanism 50 includes the pair of left and right input arms 51, a swing shaft 52, a follower 53, and a cam 58.

The swing shaft 52 extends in the left-right direction across substantially the entire width of the housing 26 in the left-right direction within the housing 26 and is rotatably supported by the housing 26. The swing shaft 52 holds the pair of input arms 51 substantially at the midpoint in the longitudinal direction and imparts a turning motion to the pair of input arms 51. Further, on both sides of the pair of input arms 51, the swing shaft 52 holds the aforementioned sorting members 23 and rotates the sorting members 23 in conjunction with the input arms 51.

The pair of input arms 51 extends rearward from the swing shaft 52 and are positioned adjacent to both the left and right sides of the support part 32. Each input arm 51 has a long hole 511 extending therethrough in the left-right direction. The left and right input shafts 39 of the support part 32 are inserted through the respective long holes 511.

Thus, the support part 32 can be swung around the support shaft 38 by the swing of the input arm 51 around the swing shaft 52. In this case, since the input arm 51 has the long hole 511, the input shaft 39 is allowed to move along the long hole 511.

The longitudinal direction of each long hole 511 is preferably closer to the radial direction about the swing shaft 52 than a direction orthogonal to that radial direction.

An arm-shaped follower 53 serving as a follower of the cam 58 is held at a right end portion of the swing shaft 52. The follower 53 extends frontward, with its lower portion contacting the outer periphery of the cam 58. In addition, a coil spring 56 is coupled to the tip of the follower 53 to maintain the contact with the cam 58, with downward tension applied.

The cam 58 is an outer periphery cam that rotates around an axis extending in the left-right direction. In the circumferential direction, the cam 58 has a segment with a minimum diameter and a segment with a maximum diameter, with an intermediate segment in which the diameter gradually increases. In addition, the segment of the cam 58 with the maximum diameter is an adjustment segment 581 in which the outer diameter remains the same over a certain angular range in the circumferential direction.

When the follower 53 contacts the segment of the cam 58 with the minimum diameter, the tip of the follower 53 is raised to its highest position, and the rotary conveyance body 31 is located at the retracted position illustrated in FIG. 6.

When the follower 53 contacts the adjustment segment 581 of the cam 58, the tip of the follower 53 is lowered to its lowest position, and the rotary conveyance body 31 is located at the conveyance position illustrated in FIG. 7.

The adjustment segment 581 is a segment in which the rotary conveyance body 31 is brought closest to the storage tray 24 by the cam 58. Therefore, the height adjustment operation of the adjustment part 40 for the rotary conveyance body 31 is performed while the adjustment segment 581 of the cam 58 is in contact with the follower 53. Therefore, as illustrated in FIG. 7, the cam 58 is provided with a positioning hole 582 as a mounting portion for a jig that fixes the shaft angle in the adjustment segment 581.

The cam 58 is supported by a right bracket 262 that is adjacent to and opposite to the cam 58. In the right bracket 262, an insertion hole 262a for the jig is formed corresponding to the positioning hole 582 of the cam 58 that is in contact with the follower 53 in the adjustment segment 581.

The jig (not shown) is formed of a round bar. The cam 58 can be fixed at the shaft angle of the adjustment segment 581 by simultaneously inserting the jig through the positioning hole 582 and the insertion hole 262a with the positioning hole 582 and the insertion hole 262a aligned.

The cam 58 is connected to a cam drive motor 54 serving as a drive source via a speed reducer (not illustrated). The cam drive motor 54 includes a motor, for example, a stepping motor or the like that can control an operation amount such as the shaft angle of an output shaft. The cam 58 includes a disk in which a notch is formed. The cam 58 is provided with a sensor 55 for detecting the notch of the disk. The shaft angle at which the sensor 55 detects the notch is the origin of the cam 58. The cam drive motor 54 is controlled such that the segment with the minimum diameter or the adjustment segment 581 comes in contact with the follower 53 according to the detected operation amount from the origin.

### Post-Processing Device: Conveyance Operation

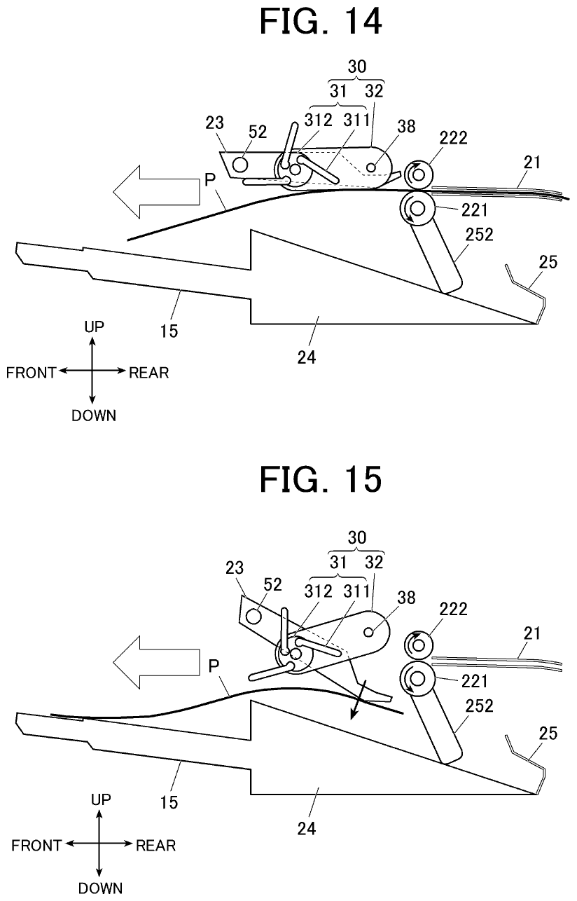

FIGS. 14 to 19 are diagrams sequentially illustrating an operation of the post-processing device 20. The operation of the post-processing device 20 will be sequentially described with reference to these drawings.

The post-processing device 20 initially controls the cam drive motor 54 such that the rotary conveyance body 31 is at the retracted position.

When the recording medium P on which image formation has been performed reaches the path member 21, the post-processing device 20 further conveys the recording medium P frontward by the conveyance section 22 (FIG. 14).

Then, the cam drive motor 54 begins driving, causing the sorting member 23 to swing and drop the rear end portion of the recording medium P toward the storage tray 24 (FIG. 15).

The cam drive motor 54 continues driving until each rotary conveyance body 31 reaches the conveyance position.

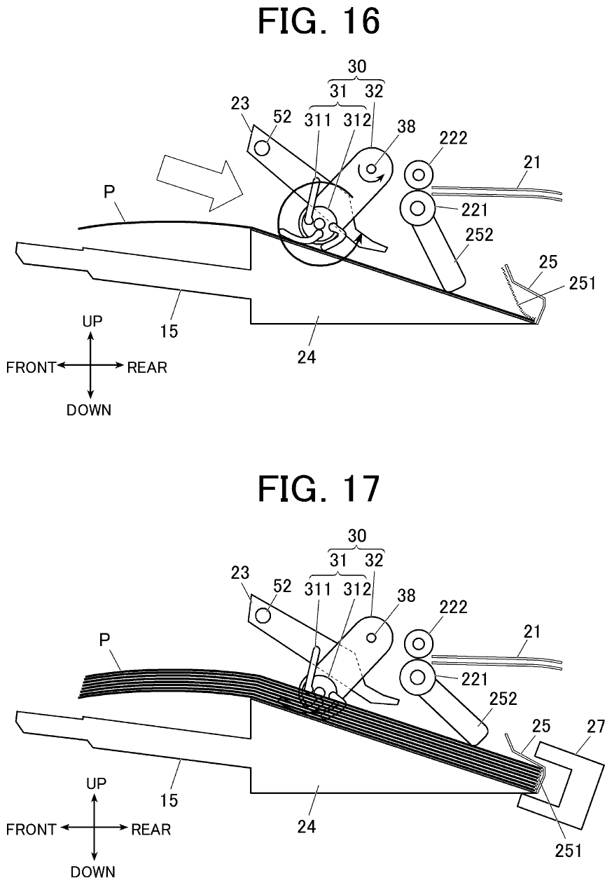

Next, the conveyance motor 223 drives the rotary conveyance body 31 to rotate via the support shaft 38 and the transmission mechanism 36 to convey the recording medium P rearward (FIG. 16).

The recording medium P is conveyed along the upper surface of the storage tray 24 by the pressing plate 252 until the rear end of the recording medium P reaches the rear portion of the end stopper 25.

Thereafter, the rotary conveyance body 31 is temporarily returned to the retracted position by driving of the cam drive motor 54.

A target number of sheets of the recording medium P is set in advance, and the recording medium P on which an image has been formed is repeatedly conveyed to the post-processing device 20. The post-processing device 20 repeatedly executes the operations in FIGS. 14 to 16 each time the recording medium P arrives.

In this case, the height of the rotary conveyance body 31 may be adjusted for each sheet or for a predetermined number of sheets by utilizing the segment in which the diameter of the cam 58 changes. That is, control may be performed such that the height of the rotary conveyance body 31 is gradually increased as the number of stacked sheets increases to maintain the contact pressure constant.

This allows each recording medium P to be stacked on the storage tray 24. In addition, since each recording medium P is abutted against the end stopper 25, the recording media P are stacked with the positions of the rear ends aligned.

When the target number of the recording media P are stacked, the stapling unit 27 moves frontward (FIG. 17). The stapling unit 27 binds the recording media P by driving a staple needle N through the rear ends of the stacked recording media P at a position avoiding the end stoppers 25.

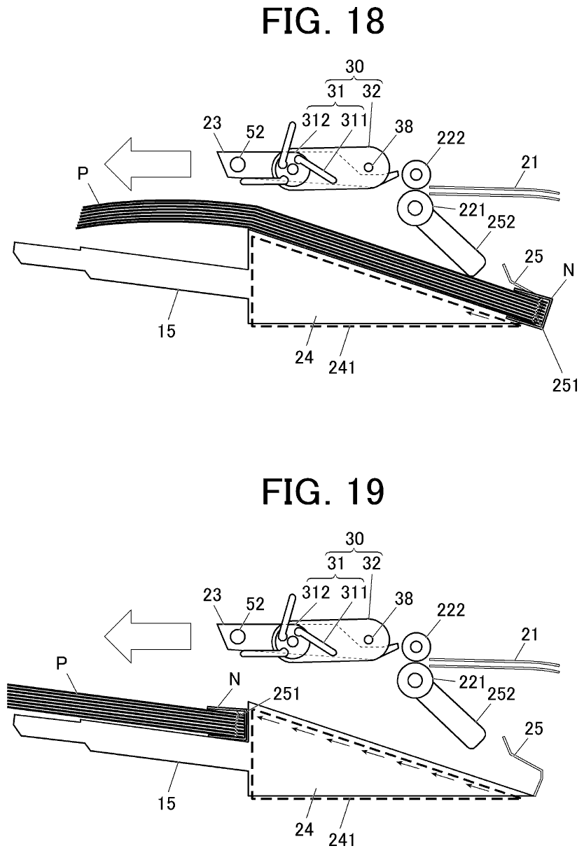

Next, a conveyance belt mechanism 241 moves upward from between the two storage trays 24, bringing a belt into contact with the bottom surface of the lowermost recording medium P (FIG. 18).

Further, the conveyance belt mechanism 241 begins driving, conveying the bound recording media P frontward and ejecting the recording media P onto the ejection tray 15 to complete the operation (FIG. 19).

### Post-Processing Device: Adjustment Operation

An operation of adjusting the height of the rotary conveyance body 31 by the adjustment part 40 of the post-processing device 20 will be described with reference to FIGS. 7 to 13.

This adjustment operation can be performed at the shipment stage of the post-processing device 20 or before starting the post-processing.

As illustrated in FIG. 7, the cam 58 is turned to a shaft angle at which the adjustment segment 581 is located on the upper side, and the jig is inserted through the positioning hole 582 and the insertion hole 262a simultaneously. Thus, each rotary conveyance body 31 is located at the conveyance position.

In this state, if necessary, the coupling member 42 is loosened to move the adjustment body 41 frontward or rearward via the guide protrusion 43 while observing the scale 344.

Since the paddles 311 of the rotary conveyance body 31 have elasticity, the contact pressure against the uppermost recording medium P changes according to the height of the rotary conveyance body 31. When the contact pressure is high, the conveying force of the rotary conveyance body 31 on the recording medium P increases. When the contact pressure is low, the conveying force of the rotary conveyance body 31 on the recording medium P decreases.

Therefore, the post-processing device 20 adjusts the conveying force by changing the height of the rotary conveyance body 31. When the adjustment body 41 is moved rearward, the angle θn increases (FIG. 10), and the height of the rotary conveyance body 31 can be lowered (FIG. 12). When the adjustment body 41 is moved frontward, the angle θn decreases (FIG. 11), and the height of the rotary conveyance body 31 can be increased (FIG. 13).

The height of the rotary conveyance body 31 from the storage tray 24 is changed by the front-rear movement of the adjustment body 41, and the conveying force can be easily and finely adjusted.

### Technical Effects of First Embodiment

In the post-processing device 20, the support part 32 is provided with the adjustment part 40 for adjusting the height of the rotary conveyance body 31. This makes it possible to adjust the height of the rotary conveyance body 31 at a position close to the rotary conveyance body 31 where the number of interposed components is small. Therefore, the height of the rotary conveyance body 31 can be adjusted to the desired level while minimizing the influence of interposed components, and the conveying force of the rotary conveyance body 31 can be finely adjusted more appropriately.

Thus, the post-processing device 20 can prevent the edges of the recording media P from becoming uneven or buckling and can properly align the edges.

In the rotary conveyance body 31, each of the paddles 311 is made of an elastic member. Consequently, an elastic force exerted by the paddle 311 on the recording medium P is generated due to the height of the rotary conveyance body 31. Therefore, the conveying force is easily adjusted by changing the height of the rotary conveyance body 31, and thus it is possible to finely and appropriately adjust the conveying force.

In addition, in the rotary conveyance body 31, each of the paddles 311 is held by the paddle holder 312. Therefore, replacement of the paddles 311 in the paddle holder 312 is facilitated. Furthermore, even when the paddle 311 is made of an elastic member, a material capable of strongly holding the paddle 311 can be selected for the paddle holder 312. Therefore, while retaining the advantages of the elastic paddle 311, the recording medium P can be conveyed in a securely held state, enabling satisfactory conveyance.

The support part 32 of the rotary conveyance body 31 is supported by the support shaft 38 different from the rotary shaft 37. Therefore, the adjustment body 41 for adjusting the height of the rotary conveyance body 31 can be provided between the rotary shaft 37 and the support shaft 38, and the design of the adjustment body 41 is facilitated. Furthermore, it is possible to increase the degree of freedom in designing the adjustment body 41.

Furthermore, the adjustment part 40 adjusts the height of the rotary conveyance body 31 by changing the angle of the rotary conveyance body 31 about the support shaft 38 of the support part 32. Therefore, the height of the rotary conveyance body 31 can be easily adjusted by swinging the support part 32 around the support shaft 38.

Further, the rotary conveyance body 31 receives, via an input shaft 39 different from both the rotary shaft 37 and the support shaft 38, an input for a swing motion around the support shaft 38. Therefore, it is possible to switch between the retracted position and the conveyance position of the rotary conveyance body 31 without affecting the adjustment of the height of the rotary conveyance body 31 by the adjustment part 40.

Further, the adjustment part 40 adjusts the height of the rotary conveyance body 31 by changing the angle θn, about the support shaft 38, formed between the position of the rotary shaft 37 and the position of the input shaft 39. Therefore, it is easy to incorporate the configuration of the adjustment part 40 to adjust the height of the rotary conveyance body 31 into the support part 32.

Further, the height of the rotary conveyance body 31 can be adjusted by changing the angle around the support shaft 38, with a radius equal to the distance to either the rotary shaft 37 or the input shaft 39. Therefore, the size of the support part 32 can be reduced, which contributes to the size reduction of the post-processing device 20.

For the post-processing device 20 in which the recording medium processing device is incorporated in the image forming apparatus 100 or the like, there is a very high demand for size reduction. The above-described configuration of the adjustment part 40 can effectively realize the demand for the size reduction of the post-processing device 20.

In the conveyance unit 30, the pair of input shafts 39 are disposed symmetrically with respect to the drive belt 361 in the support part 32. Therefore, it is possible to realize an arrangement in which the input shafts 39 and the drive belt 361 appear to overlap when viewed from the side, while avoiding interference between the input shafts 39 and the drive belt 361.

Consequently, there is no need to position the input shafts 39 above or below the drive belt 361 to avoid interference. This enables the size reduction of the support part 32 and, furthermore, the size reduction of the post-processing device 20.

In addition, in the support part 32, the coupling shaft 321 that couples the holder 33 to the movable body 34 via the adjustment body 41 is inserted through the interior of the drive belt 361. Since the coupling shaft 321 does not move with respect to the drive belt 361, the coupling shaft 321 does not interfere with the drive belt 361 even when disposed inside the drive belt 361. In addition, since the coupling shaft 321 does not need to be disposed above or below the drive belt 361 to avoid interference, it is possible to realize the size reduction of the support part 32 and the post-processing device 20.

In addition, the movable body 34 of the conveyance unit 30 includes a pair of opposing wall portions and has a U-shaped cross-section, and the drive belt 361 is disposed to pass through the inside of the movable body 34.

Therefore, when the height of the rotary conveyance body 31 is adjusted, the movable body 34 can avoid interference with the drive belt 361. Furthermore, since the drive belt 361 can be disposed inside the movable body 34, it is possible to realize the size reduction of the support part 32 and the post-processing device 20 in the up-down direction or the left-right direction.

Further, the adjustment part 40 can adjust the height of the rotary conveyance body 31 in a stepless manner. Thus, it is possible to perform fine height adjustment without being restricted by stepwise adjustment or the like.

Furthermore, the moving mechanism 50 has the adjustment segment 581 in which the outer diameter remains the same so that the cam 58 can allow the adjustment part 40 to adjust the height of the rotary conveyance body 31.

In the adjustment of the height of the rotary conveyance body 31, even slight rotation of the cam 58 causes a change in the height of the rotary conveyance body 31, making the adjustment difficult. By providing the adjustment segment 581 in the cam 58, it is possible to suppress the height displacement of the rotary conveyance body 31 due to the rotation of the cam 58. Therefore, it is possible to easily finely adjust the rotary conveyance body 31 to a desired height.

Further, in the moving mechanism 50, the positioning hole 582 serving as a mounting portion for the jig that fixes the cam 58 in the adjustment segment 581 is provided in the cam 58.

Accordingly, it is possible to suppress the occurrence of the rotation of the cam 58 when the height of the rotary conveyance body 31 is adjusted, and to finely adjust the rotary conveyance body 31 to a desired height.

### Second Embodiment

In the following, a second embodiment of the present disclosure will be described with reference to the drawings. The scope of the present disclosure is not limited to the embodiment disclosed below or the illustrations in the drawings.

The embodiment described below illustrates a conveyance unit 30A that is partially different in configuration from the above-described conveyance unit 30. In the following description, the same components as those of the above-described image forming apparatus 100 are denoted by the same reference signs, and redundant descriptions are omitted. Differences between the conveyance unit 30A and the conveyance unit 30 will be mainly described.

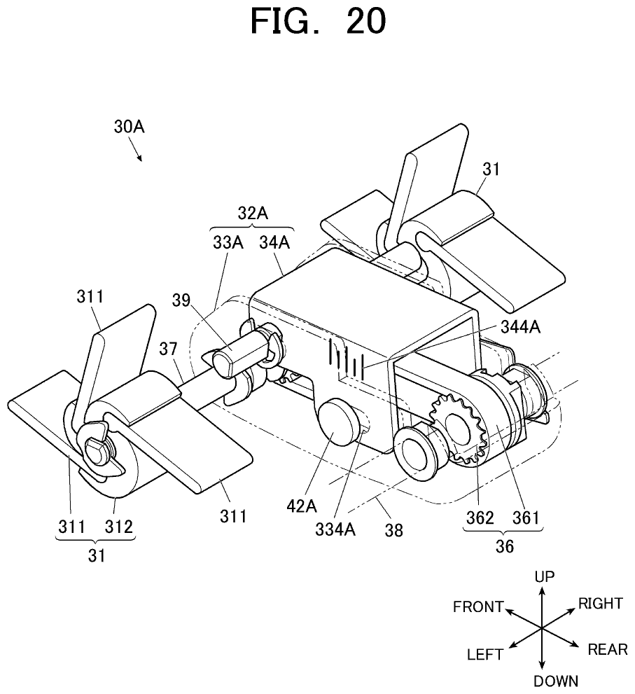

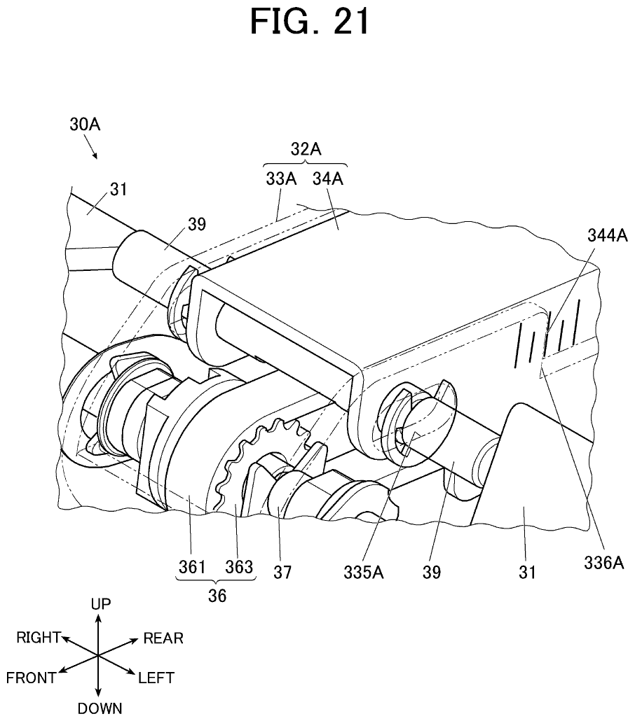

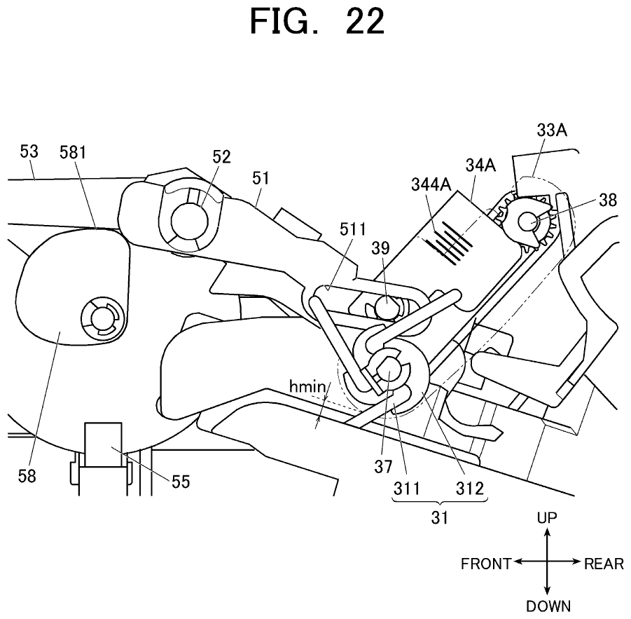

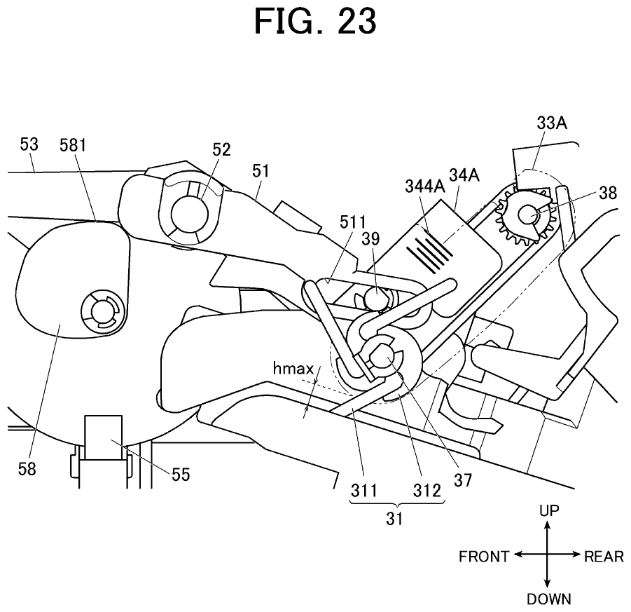

FIG. 20 is a perspective view of the conveyance unit 30A in the second embodiment. FIG. 21 is an enlarged perspective view of the conveyance unit 30A. FIG. 22 is a side view of the conveyance unit 30A as viewed from the left when a movable body 34A described later is at its rearmost position relative to a holder 33A described later. FIG. 23 is a side view of the conveyance unit 30A as viewed from the left when the movable body 34A is at its foremost position relative to the holder 33A.

The conveyance unit 30A is different from the conveyance unit 30 in the support part 32A and the adjustment part.

The support part 32A includes a holder 33A that supports the rotary shaft 37 and a movable body 34A that holds the input shafts 39.

The holder 33A is a frame body that has left and right sidewall portions and a bottom surface portion and has an open cross-sectional shape opened upward. The support shaft 38 is rotatably inserted through a rear end portion of the holder 33A, and the rotary shaft 37 is rotatably inserted through a front end portion of the holder 33A.

The holder 33A is the same as the holder 33 in that the rotational force is transmitted from the support shaft 38 to the rotary shaft 37 by the transmission mechanism 36.

The holder 33A is different from the holder 33 in that the front half of the left and right sidewall portions are set higher than the sidewall portions of the holder 33. However, the left and right sidewall portions of the holder 33A are not higher than the movable body 34A. Therefore, the conveyance unit 30A does not result in increased size in the up-down direction compared to the conveyance unit 30.

The movable body 34A is a frame body that has left and right sidewall portions and a top surface portion and has an open cross-sectional shape opened downward. The movable body 34A is coupled to the inside of the holder 33A so as to close the opened upper portion of the holder 33A.

A pair of leg portions extending rearward and obliquely downward are not provided at rear portions of the left and right sidewall portions of the movable body 34A and are not coupled around the support shaft 38.

On front sides of the left and right sidewall portions of the movable body 34A, the pair of input shafts 39 protruding outward in the left-right direction are provided. The input shafts 39 extend outward from the holder 33A through respective long holes 335A along the left-right direction formed in respective front portions of the left and right sidewall portions of the holder 33A.

The adjustment part includes a pair of left and right coupling members 42A. Note that illustration of the right coupling member 42A is omitted. Furthermore, since the movable body 34A is related to the adjustment of the height of the rotary conveyance body 31, the movable body 34A may be considered part of the adjustment part.

Each coupling member 42A couples the holder 33A to the movable body 34A. The coupling members 42A pass through respective long holes 334A along the left-right direction formed in respective rear portions of the left and right sidewall portions of the holder 33A and are mounted on the respective sidewall portions of the movable body 34A.

When the holder 33A and the movable body 34A are coupled to each other by the coupling members 42A, the left and right sidewalls of the movable body 34A and the left and right sidewalls of the holder 33A are appropriately pressed against each other. Thus, the holder 33A and the movable body 34A cannot relatively move in the front-rear direction unless a force of a certain level or more is applied.

Each of the coupling members 42A may be formed of a fastening member such as a screw, and the insertion hole of the movable body 34A may be formed of a screw hole, so that the holder 33A and the movable body 34A can be fastened to each other. In this case, when the coupling member 42A is loosened, the holder 33A and the movable body 34A can move in the front-rear direction. In addition, when the coupling member 42A is fastened, the holder 33A and the movable body 34A can be fixed.

The movable body 34A is movable in the front-rear direction relative to the holder 33A by the coupling members 42A and the input shafts 39. The coupling members 42A pass through the respective long holes 334A of the holder 33A, and the input shafts 39 pass through the respective long holes 335A of the holder 33A. The post-processing device can adjust the height of the rotary conveyance body 31 by the front-rear movement of the movable body 34A relative to the holder 33A.

A scale 344A is provided on a side surface of the movable body 34A. The scale 344A is for reading the front-rear position of the movable body 34A with respect to the holder 33A. The sidewall portion of the holder 33A is provided with an edge portion 336A along the up-down direction. The front-rear position of the movable body 34A with respect to the holder 33A can be read from the position of the edge portion 336A with respect to the scale 344A.

The front-rear position of the movable body 34A is correlated with the height of the rotary conveyance body 31. Accordingly, it is possible to adjust the height of the rotary conveyance body 31 while reading the front-rear position of the movable body 34A with respect to the holder 33A from the scale 344A.

Furthermore, the movable body 34A can also be moved relative to the holder 33A in a stepless manner, that is, continuously. Accordingly, the height of the rotary conveyance body 31 can also be adjusted in a stepless manner.

The scale 344A and the edge portion 336A may be provided on the right side of the support part 32A or on both the left and right sides.

FIG. 22 is a side view of the conveyance unit 30A illustrating the height of the rotary conveyance body 31 when the movable body 34A is moved to the rearmost position within the movable range of the movable body 34A. In this case, the input arm 51 is at a position where the rotary conveyance body 31 is set at the conveyance position.

The long hole 511 in the distal end portion of the input arm 51 is located at a predetermined position. On the other hand, when the movable body 34A moves rearward relative to the holder 33A, the input shaft 39 moves rearward along the long hole 511. As a result, the posture of the holder 33A at the conveyance position is such that the front end portion is swingably displaced rearward around the support shaft 38. Therefore, the rotary conveyance body 31 moves downward and reaches the distance hmin at which the rotary conveyance body 31 is closest to the upper surface of the storage tray 24.

FIG. 23 is a side view of the conveyance unit 30A illustrating the height of the rotary conveyance body 31 when the movable body 34A is moved to the foremost position within the movable range of the movable body 34A. Also in this case, the input arm 51 is at a position where the rotary conveyance body 31 is set at the conveyance position.

The long hole 511 in the distal end portion of the input arm 51 is located at a predetermined position. On the other hand, when the movable body 34A moves frontward relative to the holder 33A, the input shaft 39 moves frontward along the long hole 511. As a result, the posture of the holder 33A at the conveyance position is such that the front end portion is swingably displaced frontward around the support shaft 38. Therefore, the rotary conveyance body 31 moves upward and reaches the distance hmax at which the rotary conveyance body 31 is farthest from the upper surface of the storage tray 24.

Thus, the height of each rotary conveyance body 31 can be adjusted downward by the rearward movement of the movable body 34A relative to the holder 33A. In addition, the height of each rotary conveyance body 31 can be adjusted upward by the frontward movement of the movable body 34A relative to the holder 33A.

In the conveyance unit 30A, a configuration in which the movable body 34A moves frontward and rearward relative to the holder 33A is exemplified, but the present invention is not limited thereto. The height of the rotary conveyance body 31 is adjustable as long as the movable body 34A is movable relative to the holder 33A in a direction in which the distance from the input shaft 39 to the support shaft 38 changes.

### Others

Hereinabove, each embodiment of the present disclosure has been described. However, the present disclosure is not limited to the above-described embodiments. For example, in the embodiments, a constituent element integrally formed of a single member may be replaced with a constituent element divided into a plurality of members and connected or fixed to each other. In addition, a constituent element configured by connecting a plurality of members may be replaced with a constituent element integrally formed by a single member. In addition, the details described in the embodiments can be appropriately modified without departing from the spirit and scope of the invention.

In the first and second embodiments, the adjustment part can adjust the height of the rotary conveyance body 31 in a stepless manner. However, the adjustment part may be capable of adjusting the height of the rotary conveyance body in a stepwise manner.

In the case of the conveyance unit 30 according to the first embodiment, a latch mechanism or the like may be provided to cause the movable body 34 to swing around the support shaft 38 with respect to the holder 33 in increments of a predetermined angle.

In addition, in the case of the conveyance unit 30A according to the second embodiment, a latch mechanism may be provided to cause the movable body 34A to move frontward and rearward relative to the holder 33A in increments of a predetermined length.

Further, the cam 58 of the moving mechanism 50 may not be an outer periphery cam that rotates around an axis extending in the left-right direction. For example, the cam may be replaced by any type of cam capable of imparting displacement to a follower in accordance with movement of the cam or a change in posture of the cam.

Further, the rotary conveyance body is configured to include the paddles 311 but may include a roller or the like having an outer periphery made of an elastic body.

In addition, in each of the above-described embodiments, the post-processing device is exemplified as the recording medium processing device, but the present invention is not limited thereto. The configuration of the recording medium processing device described above can be applied to any device that is required to stack a plurality of recording media with their edges aligned.

Although embodiments of the present invention have been described and illustrated in detail, the disclosed embodiments are made for purposes of illustration and example only and not limitation. The scope of the present invention should be interpreted by terms of the appended claims.

What is claimed is:

1. A recording medium processing device that stacks a plurality of recording media with edges of the plurality of recording media aligned, comprising:
a storage tray on which the plurality of recording media conveyed from a conveyance route is stacked;
a restrictor that is provided at one end of the storage tray and that aligns the edges of the plurality of recording media;
a rotary conveyor that conveys the plurality of recording media on the storage tray toward the restrictor; and
a supporter that rotatably supports the rotary conveyor, wherein
the supporter is provided with an adjuster that adjusts a distance from the rotary conveyor to the storage tray or each of the plurality of recording media on the storage tray.

2. The recording medium processing device according to claim 1, wherein the rotary conveyor includes an elastic member that rotates.

3. The recording medium processing device according to claim 2, wherein the rotary conveyor includes:
a paddle that is the elastic member; and
a paddle holder that holds the paddle.

4. The recording medium processing device according to claim 1, wherein the supporter supports the rotary conveyor via a rotary shaft and is supported by a support shaft different from the rotary shaft.

5. The recording medium processing device according to claim 4, wherein the adjuster adjusts the distance from the rotary conveyor to the storage tray by changing an angle of the rotary conveyor about the support shaft of the supporter.

6. The recording medium processing device according to claim 5, wherein the rotary conveyor receives, via an input shaft different from both the rotary shaft and the support shaft, an input for a swing motion around the support shaft.

7. The recording medium processing device according to claim 6, wherein the adjuster adjusts the distance from the rotary conveyor to the storage tray by changing the angle, about the support shaft, formed between a position of the rotary shaft and a position of the input shaft.

8. The recording medium processing device according to claim 4, wherein
the rotary conveyor receives, via an input shaft different from both the rotary shaft and the support shaft, an input for a swing motion around the support shaft, and
the adjuster adjusts the distance from the rotary conveyor to the storage tray by moving the input shaft in a direction in which a distance from the input shaft to the support shaft changes.

9. The recording medium processing device according to claim 6, wherein
the supporter is provided with a drive belt that transmits rotation to the rotary shaft, and
the input shaft includes a pair of input shafts disposed symmetrically with respect to the drive belt.

10. The recording medium processing device according to claim 6, wherein
the supporter includes:
a holder that supports the rotary shaft;
a movable body that holds the input shaft;
a coupling shaft that couples the holder to the movable body; and
a drive belt that transmits rotation to the rotary shaft, and
the coupling shaft is inserted through an interior of the drive belt.

11. The recording medium processing device according to claim 10, wherein
the movable body includes a pair of sidewall portions and has a U-shaped cross-section, and
the drive belt is disposed to pass between the pair of sidewall portions.

12. The recording medium processing device according to claim 1, wherein the adjuster is capable of adjusting the distance from the rotary conveyor to the storage tray in a stepless manner.

13. The recording medium processing device according to claim 1, wherein the adjuster is capable of adjusting the distance from the rotary conveyor to the storage tray in a stepwise manner.

14. The recording medium processing device according to claim 1, further comprising a moving structure that moves the rotary conveyor by a cam in a direction in which the rotary conveyor approaches the storage tray, wherein the cam has an adjustment segment in which a displacement of the rotary conveyor remains a same with respect to a movement of the cam so as to allow the adjuster to adjust the distance from the rotary conveyor to the storage tray.

15. The recording medium processing device according to claim 14, wherein the cam has a mounting portion for a jig that fixes the cam in the adjustment segment.
